(19) United States
(12) Patent Application Publication
(10) Pub. No.: US 2016/0350692 A1
(43) Pub. Date: Dec. 1, 2016

(54) Measuring Change in Software Developer Behavior Under Pressure

(71) Applicant: International Business Machines Corporation, Armonk, NY (US)

(72) Inventors: Yurdaer N. Doganata, Chestnut Ridge, NY (US); James L. Jones, Austin, TX (US); David L. Leigh, Chapel Hill, NC (US)

(21) Appl. No.: 14/722,373

(22) Filed: May 27, 2015

(51) Int. Cl. G06Q 10/06; G06Q 10/10; G06F 9/44

(52) U.S. Cl. CPC G06Q 10/06398; G06F 8/77; G06Q 10/103

(57) ABSTRACT

In one aspect, a method for detecting changes in behavior of developers in a software development process is provided which includes the steps of: using a frequency of a number of daily software commits (N_{c}) and an average number of files submitted per software commit (N_{f}) to detect when given instances of (N_{c}, N_{f}) are below a first predetermined threshold, which is a first indicator of developer behavior under pressure; using, for comparison, an average number of messages exchanged daily by members of a plurality of software development teams to detect when a number of messages exchanged daily by members of a given software development team is below a second predetermined threshold, which is a second indicator of the developer behavior under pressure; and generating an alert if either the first indicator or the second indicator of the developer behavior under pressure occurs.

### FIELD OF THE INVENTION

The present invention relates to analyzing software developer behavior, and more particularly, to techniques for detecting changes in software behavior under pressure based on frequency of daily commits and number of files submitted during each commit and/or on amount of collaboration between members of a software development team.

### BACKGROUND OF THE INVENTION

Software developers are usually under pressure to meet release dates. When they work against time and with limited resources, they may increase a project's technical debt. That is, software developers refactor existing code as a result of poorly written code or based on an evolving understanding of a problem.

However, developers working against time seek quick and easy fixes. For example, developers under pressure frequently skip doing proper code refactoring. Quick and easy fixes almost always require modification in the future, as opposed to improving the design which takes more time to implement. Other behavioral changes include the tendency to reduce collaboration with others while working under pressure.

One effect of these shortcuts is that the code becomes more brittle as previously independent modules and components become more tightly coupled. As this type of technical debt increases, each subsequent code change is more likely to affect more source code files than would be affected if the proper code refactoring had been done.

Therefore, techniques for detecting these types of changes in the behavior of software developers under pressure and for generating insights for project management purposes would be desirable.

### SUMMARY OF THE INVENTION

The present invention provides techniques for detecting changes in software behavior under pressure based on frequency of daily commits and number of files submitted during each commit and/or on amount of collaboration between members of a software development team. In one aspect of the invention, a method for detecting changes in behavior of developers in a software development process is provided. The method includes the steps of: using a frequency of a number of daily software commits (N_{c}) and an average number of files submitted per software commit (N_{f}) to detect when given instances of (N_{c}, N_{f}) are below a first predetermined threshold, which is a first indicator of developer behavior under pressure; using, for comparison, an average number of messages exchanged daily by members of a plurality of software development teams to detect when a number of messages exchanged daily by members of a given software development team is below a second predetermined threshold, which is a second indicator of the developer behavior under pressure; and generating an alert if either the first indicator or the second indicator of the developer behavior under pressure occurs, wherein changes to the software development process can be implemented based on the alert to address the developer behavior under pressure.

In another aspect of the invention, another method for detecting changes in behavior of developers in a software development process is provided. The method includes the steps of: collecting data relating to the developer behavior under pressure, wherein the data comprises a) a number of daily software commits (N_{c}) and an average number of files submitted per software commit (N_{f}) and b) a number of messages exchanged by members of a plurality of software development teams; using the data to generate a heat map of a frequency of the number of daily software commits (N_{c}) and the average number of files submitted per software commit (N_{f}); detecting, via the heat map, when given instances of (N_{c}, N_{f}) are below a first predetermined threshold, which is a first indicator of developer behavior under pressure; using, for comparison, an average number of messages exchanged daily by members of a plurality of software development teams to detect when a number of messages exchanged daily by members of a given software development team is below a second predetermined threshold, which is a second indicator of the developer behavior under pressure; and generating an alert if, either the first indicator or the second indicator of the developer behavior under pressure occurs, wherein changes to the software development process can be implemented based on the alert to address the developer behavior under pressure.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for detecting changes in software developer behavior according to an embodiment of the present invention;

FIG. 2 is an diagram illustrating an exemplary heat map according to an embodiment of the present invention; and

FIG. 3 is a diagram illustrating an exemplary apparatus for performing one or more of the methodologies presented herein according to an embodiment of the present invention.

### DETAILED DESCRIPTION OF PREFERRED EMBODIMENTS

As provided above, the behavior of software developers often changes when the developers are under pressure to meet a deadline. For instance, the implementation of quick and easy fixes tends to increase, while collaboration with others tends to decrease, in high-pressure situations. These behavior patterns unfortunately lead to an increase in the project's technical debt.

During the software development process, different teams (of developers) create code. Once a team member has developed the code, he/she commits the changes (referred to herein as “software commits” or simply “commits”) by sending a batch of files for commit. Thus, multiple files are changed at once, i.e., each commit includes a bunch of files (see reference below to number of files submitted at each commit). During the software development process, members of a team may consult one another on different aspects of the project. For instance, team members may exchange electronic messages with one another asking for input on a particular part of the code being worked on.

Advantageously, provided herein are techniques for statistically analyzing characteristics of software developer behavior in order to detect changes in the behavior of software developers under pressure and to provide feedback which project managers can leverage to better manage the software development process. Namely, in an agile development environment, two distinct behaviors show variations under pressure. First, the frequency of software commits and the number of files submitted at every commit change. As will be described in detail below, the distribution of inter-arrival times between two commits and the distribution of the number of files at every commit are used herein as indicators of developers' stress. In a continuous delivery environment, new functions are added to the system incrementally. In a well managed development pipeline, it is expected that typical code changes do not involve large numbers of files and the variations in inter-commit times are small. On the other hand, under pressure the lack of proper code refactoring (see above) means that such typical code changes involve many files.

Second, the collaboration between team members can decrease under pressure (i.e., a developer under pressure is less likely to take the time to collaborate with another team member). The frequency of messages between two team members and their response time changes. In general, as one moves closer to a release date the pressure to hit the date increases. As a result, developer behavior changes. The present techniques use the statistical properties of the number of files submitted at every commit and the rate of message exchange between team members to detect changes in developer behaviors, thereby providing a useful metric for development managers.

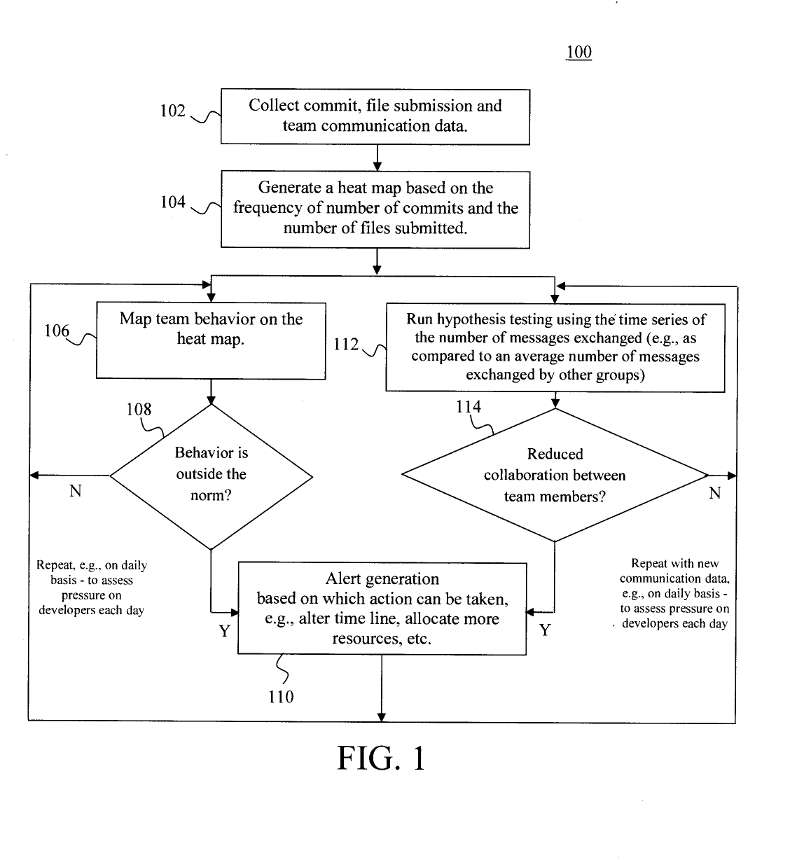

An overview of the present techniques is provided in FIG. 1. FIG. 1 is a diagram illustrating an exemplary methodology 100 for detecting changes in software developer behavior using a heat map. In step 102, software commits, file submission, and team communication data is collected from a plurality of different software development teams. As provided above, characteristics of a change in developer behavior include changes in the frequency of software commits and the number of files submitted at every commit and/or changes in the frequency of messages between team members and their response time. Thus, for instance, the data collected in step 102 may include: the number of daily software commits N_{c} and the average number of files N_{f} sent at every software commit (e.g., if there are 4 software commits for a given day, i.e., commits A, B, C, and D, and the number of files submitted for each commit is 1, 2, 2, 3, respectively, then the average number of files N_{f} sent at every software commit for that given day is 2), the number of (e.g., electronic) messages exchanged daily between team members, etc. In step 102, the data may be aggregated from many different software project development teams.

Often times teams are using the same system (version control system) to submit their code. Usually individual developers work in their local environment (machines) and use the client of the version control system to submit their work. Initially the cells of the present heat map (see below) indicate either the highest or lowest probability. The resolution of the heat map however gets better in time as the number of samples increases. That is, the more the system is used—the better the resolution gets. In general, the number of samples, n, that is required to build a heat-map is the same as the number of samples required to estimate the mean values for the number of files submitted for a given number of commits a day within 95 percent confidence. The error margin of the estimation gets smaller as the sample size increases. The assumption is that in time enough number of samples will accumulate for good heat-map resolution. For a given number of commits, in order to find the sample size n to estimate the mean number of files sent with +0.5 or −0.5 error and with 95% confidence, the following formula is used: n=4σ²/M². Here M is the margin of error or deviation from the true mean and it is 0.5, σ is the standard deviation of the population and estimated by using about 10 samples for 98% accuracy.

In step 104, a heat map is generated based on the frequency of the software commits and the number of files submitted at every commit. The process for creating this heat map is described in detail below.

Once created, the heat map can then be used to evaluate the behavior of a given software development team or teams. For instance, in step 106 a team's behavior is mapped on the heat map and, from that mapping, in step 108 a determination is made as to whether or not the team's behavior is outside of the norm. The process for evaluating the mapped data against normal behavior is described in detail below.

If it is determined that (yes (Y)) the team's behavior is outside of normal parameters, then in step 110, an alert of this behavior can be generated. By way of example only, the project manager can be alerted (e.g., via an electronic message) in step 110 that the frequency of software commits and/or the number of files submitted at every commit for one or more teams is outside of the norm. Once notified, the project manager can then take action to address/alleviate pressure on the team in question. For instance, the project manager might increase the time line, increase the resources (e.g., put more developers on the project), and/or reallocate tasks, etc. On the other hand, if it is determined in step 108 that (No (N)) the team's behavior is not outside normal parameters, then that iteration of the process ends. In either case, as shown in FIG. 1, updated team data can be mapped to the heat map at regular intervals, e.g., daily—so as to assess the pressure the software developers are under each day, and the process repeated.

As provided above, a reduction in the collaboration between developers can be an indicator of high stress behavior in software development teams. Thus, this parameter is also evaluated in methodology 100. For instance, based on the team communication data collected in step 102, hypothesis testing is run in step 112 for each team using a time series of the number of messages exchanged. The process for this hypothesis testing will be described in detail below.

Based on the outcome from step 112, a determination is then made as to whether or not there is reduced collaboration between team members (i.e., the number of messages exchanged between team members is outside of normal parameters). See step 114. If it is determined that (yes (Y)) there is a reduction in collaboration between members of a given team (i.e., a behavior indicative of a stress situation) then, as described above, in step 110 an alert of this behavior can be generated. Upon receiving such an alert, the project manager can increase the time line, increase the resources, reallocate tasks, etc. with a goal to lessening the stress on the team in question. On the other hand, if it is determined in step 114 that (No (N)) the team's behavior is not outside normal parameters, then that iteration of the process ends. In either case, as shown in FIG. 1, updated communication data can be collected and evaluated at regular intervals, e.g., daily—so as to assess the pressure the software developers are under each day, and the process repeated.

While it is desirable to collect and evaluate data relating to both a) the frequency of software commits/the average number of files submitted at every commit and b) the amount of communication between team members, as shown in FIG. 1 each of these indicators of developer behavior can independently be the basis for generating an alert to the project manager. Thus, advantageously multiple metrics are provided herein for developer behavior evaluation.

Given the above overview, a detailed description of the various techniques employed herein is now provided. As described in conjunction with the description of step 102 above, data is collected from multiple teams regarding the number of daily software commits and the average number of files sent at every software commit, the number of (e.g., electronic) messages exchanged daily between members of each team, etc.

In order to create a benchmark for the behavior of the software developers, the data is aggregated from many different software projects. According to an exemplary embodiment, the data collected in step 102 contains the number of daily commits for each team as well as the number of files sent at every commit. Since the behavior is represented with two parameters, a goal is to create a matrix from the aggregated pairs of (N_{c}, N_{f})ᵢⱼ to represent the behavior using a heat map. Here, N_{c} is the number of commits and N_{f} is the average numbers of files sent per commit for team i on day j.

Let H (hₖ, hₗ) be an M×K matrix created to generate a heat map to represent the number of files submitted per commit against the number of daily commits made by the developers. Here, the entries of the matrix H are generated by bins for (N_{c}, N_{f})ᵢⱼ pairs.

$$\begin{matrix}H ( {h}_{k} , {h}_{l} ) = \frac{1}{ϕ} {Σ}_{i , j} {δ}_{k , l} [ {( {N}_{c} , {N}_{f} )}_{ij} ] \\ where & ( 1 ) \\ {δ}_{k , l} [ {( {N}_{c} , {N}_{f} )}_{ij} ] = \{ \begin{matrix}1 & \begin{matrix}if \frac{( k - 1 ) {N}_{c , max}}{M} < {N}_{c} < \frac{{kN}_{c , max}}{M} and \\ \frac{( l - 1 ) {N}_{f , max}}{K} < {N}_{f} \frac{{IN}_{f , max}}{K}\end{matrix} \\ 0 & Otherwise\end{matrix} & ( 2 )\end{matrix}$$

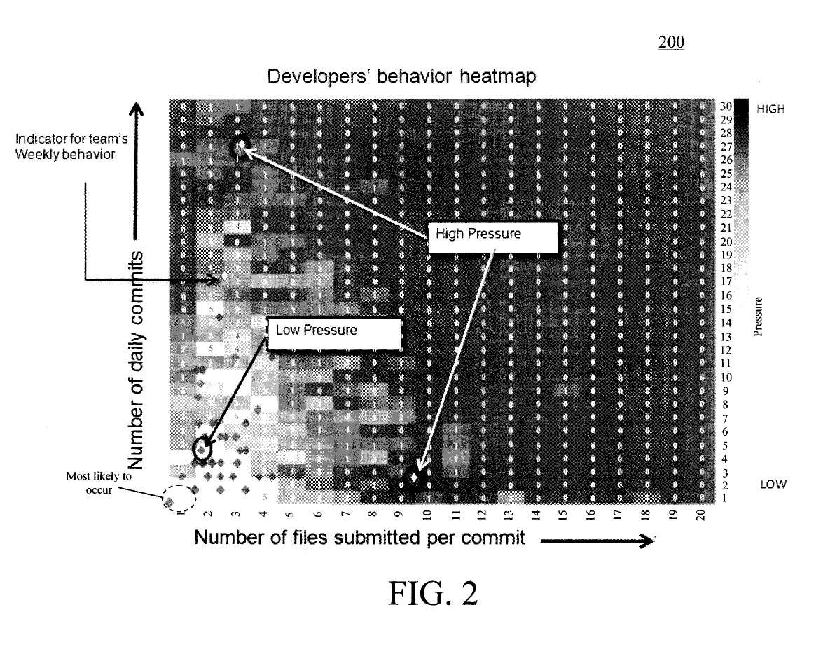

N_{c,max} is the maximum number of commits per day and N_{f,max} is the maximum of the average number of files sent. M is the number of rows and K is the number of columns of the heat map matrix. φ is the normalization constant to keep the values of the entries of the heat map matrix between 0 and 1 (it is notable that the heat map in FIG. 2 (described below) is not normalized—and each entry should be divided to the sum of all entries in the matrix; the shading is not affected by normalization).

Details of the heat map matrix are now provided. The entries of the matrix H take a value between 0 and 1. Each entry in the matrix H represents the ratio of number of commits-to-number of files per commit for all cases which satisfy the condition given by Equation 2 above. As will be described in detail below, each entry in the matrix will be shaded (to form a heat map) to indicate the likelihood of a particular case (i.e. a particular number of commits-to-number of files per commit) based on the frequency of the data collected. Namely, as the value of an entry H (hₖ , hₗ) increases, the behavior that is represented by the pairs (N_{c}, N_{f}) that contributes to the value of that particular matrix entry becomes more likely. As an example, let's assume that (N_{c}, N_{f})=(5.3.5) contributes to the value of H(5.3) which is 0.006. This means that the likelihood of making 5 commitments daily with an average number of files per commit of between 3.0 and 4.0 is 6 in a thousand.

The heat map is created by shading the entries of the matrix H based on their value. For illustrative purposes only, an exemplary heat map 200 is shown in FIG. 2. In heat map 200, the number of daily commits is plotted against the average number of files submitted per commit. In this example, the entries that are more likely to occur are a lighter shade in heat map 200 and the entries that are less likely to occur are a darker shade in heat map 200. The shading of frequency of occurrences changes from light to dark as the frequency reduces from high to low, respectively. The legend to the right of the heat map indicates the shading associated with high pressure (labeled “HIGH”)/low occurrence and low pressure (labeled “LOW”)/high occurrence. In summary, when the behavior of a given team (or teams) does not conform with the behavior of other teams at large then it is assumed that the given team(s) is under pressure. The darker the shading is, the more the pressure on the team is.

As provided above, the entries of the matrix H are shaded based on their value to create the heat map. By way of example only, the amount of the shading (lighter or darker) for each entry in the matrix can be determined based on statistical averages. For instance, one possible shading scheme could be based on likelihood. For instance, if the likelihood of being in a cell is less than x1, it is the darkest; and more than x2, it is the lightest. If the likelihood is between x1 and x2, then it is in between. Here x1<x2<1. According to an exemplary embodiment, the threshold values for x1, x2 and others (also referred to herein as “a likelihood threshold”) are decided by the project manager and can be adjusted. For example, a project manager may decide that the percentage of developers that fall on a cell in the matrix must be greater than x1=5% to determine that the behavior is not unusual. As an example, in that case if the value of the cell (7.4) in the heat map is 0.04, it means that only 4 percent of the developers make 4 commits a day and send 7 files at every commit on the average. This cell is colored dark for it represents a behavior outside the norm. Similarly, x2, x3, and other threshold values can be set to characterize a group behavior and they represent different shades. The task of setting the thresholds is left to the project managers to decide and adjust as the project continues.

The values (0, 1, 2, 3, . . ., 10) shown in the cells of heat map 200 indicate the likelihood that a given (N_{c}, N_{f}) cell entry occurs. The values correspond to the shading. For instance, the entries with the darkest shading have a value of 0. The value increases as the shading becomes lighter (and the likelihood of occurrence becomes greater). For instance, in FIG. 2 entries with the lightest shading have a value of 10, and those in between have values ranging between 1 and 9.

According to an exemplary embodiment, the heat map is then used to identify high pressure cases. Namely, once the heat map is constructed, it can be used to measure the pressure on software developers every day by mapping the number of commits and the average number of files sent per commit (e.g., each day N_{c} and N_{f} values are determined and the pressure value from the heat map is determined by looking at the corresponding entry where N_{c} is the Y, N_{f} is the X value). The diamonds used in heat map 200 represent how a team is doing on a particular day. In this example, most of the diamonds are on the lighter shaded regions indicating that the team does not increase the technical debt or that the team refactors code properly (see above). There are a few days, however, such as when the number of commits is 3 but the average number of files sent per commit reaches to 10, when the team goes into the darker shaded region where the pressure is considered high. See FIG. 2 where entries are labeled “High Pressure.” It is notable that the heat map dynamically changes every time new data is added to it. The pressure depends on the norm statistically set by the developers' behavior.

Further, as noted in the FIG. 2, indicators for a team's weekly behavior may also be gleaned from the heat map data. Namely, N_{c} and N_{f} values can be averaged daily or weekly, where the weekly behavior is the average of seven days.

As provided above, another factor that indicates high pressure is reduced collaboration between the team members. According to an exemplary embodiment, the collaboration of team members is assessed using hypothesis testing by comparing a first data set containing the time series of the number of messages exchanged by the members of a given team and a second data set containing the time series of the average number of messages exchanged by members of other teams. As is known in the art, a time series is basically a sequence of data points corresponding to measurements made over a time interval. In this case, for example, the time series would be the number of messages exchanged by team members over the time interval of a day (i.e., number of daily email exchanges). According to an exemplary embodiment, analysis of variance (ANOVA) techniques are used to compare the two data sets. As is known in the art, ANOVA is a statistical technique that involves analyzing the differences between group means. ANOVA can be used to quantify whether or not the means of two (or more) groups are equal, and if so whether the difference is statistically significant. Thus, if the collaboration data extracted from a given team is different from the collaboration data aggregated from the other teams and that difference is statistically significant, i.e., the first data set is significantly different from the second data set, then it is assumed herein that the (team communication) behavior of that given team has changed, i.e., which is indicative herein of an increase in pressure on the given team.

Thus, according to an exemplary embodiment, a statistical test is used to determine whether or not the mean of the observed number of message exchanged during a day (or a week) for a given team in question is equal to the means obtained by averaging out the number of messages exchanged by other groups during the same period. Mainly this involves two time series, the first one is the observed messages exchanged during the day (or the week) for the team in question. The second one is obtained for the same number of points by averaging the number of messages generated by other groups. As an example, data can be collected every hour and a time series generated with 24 points (i.e., the 24 hours in a day). Then we look at the averages for the messages collected every hour by averaging out the messages generated by other groups. There still are 24 points. A t-test can be used, for example, to compare these two groups. The significance level chosen for statistical significance will be the threshold. If the t-test agrees that the means are the same with 95% confidence, then it is concluded that there is no change in the behavior of the given team under observation. On the other hand, if the t-test cannot confirm that the means are the same, then it is assumed that the behavior (of the given team) has changed. If the observed means is less, in this case, it is an indication of pressure.

As provided above, alerting can be used to notify (e.g., project managers) when a development team is exhibiting behavior of being under pressure. By way of example only, the number of commits and the average numbers of files sent per commit for each team is collected every day. Then the parameters of the heat map are determined which includes the threshold values to determine the colors/shades for various pressure levels. Once the data is collected and threshold values are set, teams are placed on the heat map based on their behavior. Also, the time series of the number of messages exchanged among the team members is used to run hypothesis testing to decide if the communication is reduced. An alert is generated if either the team is placed in the darker (under pressure) regions on the heat map or the test concludes that collaboration is reduced between the team members. When alerted, project managers can take actions aimed to reduce the pressure, such as increase the timeline, allocate additional resources, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

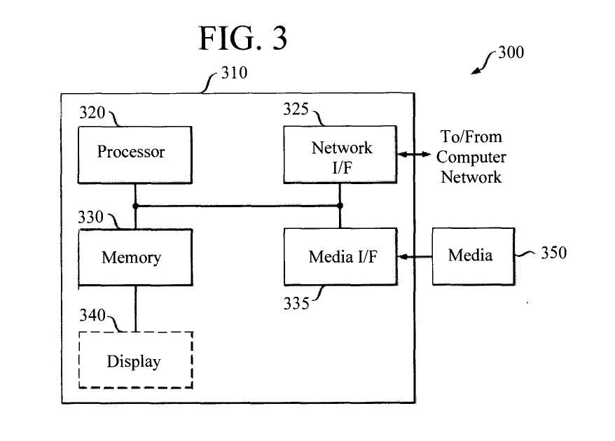

Turning now to FIG. 3, a block diagram is shown of an apparatus 300 for implementing one or more of the methodologies presented herein. By way of example only, apparatus 300 can be configured to implement one or more of the steps of methodology 100 of FIG. 1.

Apparatus 300 includes a computer system 310 and removable media 350. Computer system 310 includes a processor device 320, a network interface 325, a memory 330, a media interface 335 and an optional display 340. Network interface 325 allows computer system 510 to connect to a network, while media interface 335 allows computer system 310 to interact with media, such as a hard drive or removable media 350.

Processor device 320 can be configured to implement the methods, steps, and functions disclosed herein. The memory 330 could be distributed or local and the processor device 320 could be distributed or singular. The memory 330 could be implemented as an electrical, magnetic or optical memory, or any combination of these or other types of storage devices. Moreover, the term “memory” should be construed broadly enough to encompass any information able to be read from, or written to, an address in the addressable space accessed by processor device 320. With this definition, information on a network, accessible through network interface 325, is still within memory 330 because the processor device 320 can retrieve the information from the network. It should be noted that each distributed processor that makes up processor device 320 generally contains its own addressable memory space. It should also be noted that some or all of computer system 310 can be incorporated into an application-specific or general-use integrated circuit.

Optional display 340 is any type of display suitable for interacting with a human user of apparatus 300. Generally, display 340 is a computer monitor or other similar display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for detecting changes in behavior of developers in a software development process, the method comprising the steps of:
using a frequency of a number of daily software commits (N_{c}) and an average number of files submitted per software commit (N_{f}) to detect when given instances of (N_{c}, N_{f}) are below a first predetermined threshold, which is a first indicator of developer behavior under pressure;
using, for comparison, an average number of messages exchanged daily by members of a plurality of software development teams to detect when a number of messages exchanged daily by members of a given software development team is below a second predetermined threshold, which is a second indicator of the developer behavior under pressure; and
generating an alert if either the first indicator or the second indicator of the developer behavior under pressure occurs,
wherein changes to the software development process can be implemented based on the alert to address the developer behavior under pressure.

2. The method of claim 1, further comprising the step of:
collecting data relating to the developer behavior under pressure, wherein the data comprises a) the number of daily software commits (N_{c}) and the average number of files submitted per software commit (N_{f}) and b) a number of messages exchanged by members of the plurality of software development teams.

3. The method of claim 2, further comprising the step of:
generating a heat map based on the data relating to the number of daily software commits (N_{c}) and the average number of files submitted per software commit (N_{f}).

4. The method of claim 3, further comprising the step of:
mapping behavior of the given software development team on the heat map to determine whether the behavior of the given software development team is below the first predetermined threshold.

5. The method of claim 4, further comprising the step of:
repeating the mapping step on a daily basis in order to measure the pressure software developers are under on a daily basis.

6. The method of claim 3, wherein the heat map contains entries indicating the number of daily software commits (N_{c}) and the average number of files submitted per software commit (N_{f}), and wherein shading is used in the heat map to indicate a frequency of occurrence of each of the entries.

7. The method of claim 6, wherein the frequency of occurrence is correlated with an amount of pressure the software developers are under.

8. The method of claim 1, further comprising the step of:
using hypothesis testing with a time series of the number of messages exchanged daily by the members of the plurality of software development teams and a time series of the number of messages exchanged daily by the members of the given software development team to determine whether collaboration between the members of the given software development team has changed.

9. The method of claim 8, further comprising the step of:
comparing a first data set comprising the time series of the number of messages exchanged daily by the members of the given software development team with a second data set comprising the time series of the average number of messages exchanged daily by the members of the plurality of software development teams.

10. The method of claim 9, wherein the first data set and the second data set are compared using analysis of variance (ANOVA).

11. The method of claim 10, wherein ANOVA is used to determine whether differences between the first data set and the second data are statistically significant, wherein differences between the first data set and the second data that are statistically significant indicate that the collaboration between the members of the given software development team has changed.

12. The method of claim 1, wherein the alert comprises a message sent to a project manager.

13. A method for detecting changes in behavior of developers in a software development process, the method comprising the steps of:
collecting data relating to the developer behavior under pressure, wherein the data comprises a) a number of daily software commits (N_{c}) and an average number of files submitted per software commit (N_{f}) and b) a number of messages exchanged by members of a plurality of software development teams;
using the data to generate a heat map of a frequency of the number of daily software commits (N_{c}) and the average number of files submitted per software commit (N_{f});
detecting, via the heat map, when given instances of (N_{c}, N_{f},) are below a first predetermined threshold, which is a first indicator of developer behavior under pressure;
using, for comparison, an average number of messages exchanged daily by members of a plurality of software development teams to detect when a number of messages exchanged daily by members of a given software development team is below a second predetermined threshold, which is a second indicator of the developer behavior under pressure; and
generating an alert if either the first indicator or the second indicator of the developer behavior under pressure occurs,
wherein changes to the software development process can be implemented based on the alert to address the developer behavior under pressure.

14. The method of claim 13, further comprising the step of:
mapping behavior of the given software development team on the heat map to determine whether the behavior of the given software development team is below the first predetermined threshold.

15. The method of claim 14, further comprising the step of:
repeating the mapping step on a daily basis in order measure the pressure software developers are under on a daily basis.

16. The method of claim 13, wherein the heat map contains entries indicating the number of daily software commits (N_{c}) and the average number of files submitted per software commit (N_{f}), and wherein shading is used in the heat map to indicate a frequency of occurrence of each of the entries.

17. The method of claim 16, wherein the frequency of occurrence is correlated with an amount of pressure the software developers are under.

18. The method of claim 13, further comprising the step of:
using hypothesis testing with a time series of the number of messages exchanged daily by the members of the plurality of software developments teams and a time series of the number of messages exchanged daily by the members of the given software development team to determine whether collaboration between the members of the given software development team has changed.

19. The method of claim 18, further comprising the step of:
comparing a first data set comprising the time series of the number of messages exchanged daily by the members of the given software development team with a second data set comprising the time series of the average number of messages exchanged daily by the members of the plurality of software development team.

20. A computer program product for detecting changes in behavior of developers in a software development process, the computer program product comprising a computer readable storage medium having program instructions embodied therewith, the program instructions executable by a computer to cause the computer to:
collect data relating to the developer behavior under pressure, wherein the data comprises a) a number of daily software commits (N_{c}) and an average number of files submitted per software commit (N_{f}) and b) a number of messages exchanged by members of a plurality of software development teams;
use the data to generate a heat map of a frequency of the number of daily software commits (N_{c}) and the average number of files submitted per software commit (N_{f});
detect, via the heat map, when given instances of (N_{c}, N_{f}) are below a first predetermined threshold, which is a first indicator of developer behavior under pressure;
use, for comparison, an average number of messages exchanged daily by members of a plurality of software development teams to detect when a number of messages exchanged daily by members of a given software development team is below a second predetermined threshold, which is a second indicator of the developer behavior under pressure; and
generate an alert if either the first indicator or the second indicator of the developer behavior under pressure occurs,
wherein changes to the software development process can be implemented based on the alert to address the developer behavior under pressure.
